(19) United States
(12) Patent Application Publication
(10) Pub. No.: US 2004/0015607 A1
(43) Pub. Date: Jan. 22, 2004

(54) System and method for using an IP address as a wireless unit identifier

(76) Inventors: Paul E. Bender, San Diego, CA (US); Ramin Rezaiifar, San Diego, CA (US)

Correspondence Address: Qualcomm Incorporated, Patents Department, 5775 Morehouse Drive, San Diego, CA, 92121-1714, US

(21) Appl. No.: 10/620,724

(22) Filed: Jul. 15, 2003

Related U.S. Application Data
(63) Continuation-in-part of application No. 09/494,204, filed on Jan. 28, 2000.

(51) Int. Cl. G06F 15/173

(52) U.S. Cl. 709/238; 709/245

(57) ABSTRACT

Assignment of a session information IP address for use as a mobile station identifier facilitates a distributed architecture for processing IP communications in coordination with a wireless communication system. The session information IP address identifies a storage location of session information for a given AT. The AT effectively carries a pointer to the session information, wherein an access point is able to access the session information directly. This avoids the need to store mapping information for each AT and associated location of session information. Additionally, use of an IP address identifying the session holder as a mobile station identifier avoid delays incurred by such mapping. The session information IP address may be compressed to use a locally unique value. The compressed version conserves bit space, and reduces processing complexity on relocation to a next access point.

### CLAIM OF PRIORITY UNDER 35 U.S.C. §120

The present Application for Patent is a Continuation in Part and claims priority to U.S. patent application Ser. No. 09/494,204 entitled “SYSTEM AND METHOD FOR USING AN IP ADDRESS AS A WIRELESS UNIT IDENTIFIER” filed Jan. 28, 2000, now allowed, and assigned to the assignee hereof and hereby expressly incorporated by reference herein.

### BACKGROUND

1. Field of the Invention

The invention relates to wireless communication systems. More particularly, the invention relates to wireless networks.

2. Description of the Related Art

Data networks which provide wired connectivity to a set of users are a vital part of the business, academic and consumer environment today. For example, one of the largest data networks in the world is the Internet. In addition to the Internet, many organizations have private networks to which access is limited to a select number of users. For example, a corporation may have an internal data network which interconnects its computers, servers, dumb terminals, printers, inventories and test equipment using a wired Ethernet topology.

When a system user leaves his desk, he often does not wish to lose his connection to the data network. If the user attends a meeting within his organization, he may wish to bring his computer and print out documents on a local printer. He may also wish to maintain connectivity to the data network while moving between his office and the meeting so that he may, for example, continue to download or print a large file, maintain contact with colleagues, or simply avoid re-initiating the connection when he reaches his final destination. All of the functions can be supported through the use of a distributed wireless data network.

FIG. 1 is a block diagram of a distributed wireless data network architecture. In FIG. 1, a series of network access points 12A-12N are distributed throughout a service area. In a typical configuration, each network access point 12 has one or more antennas which provide a corresponding coverage area which abuts one or more coverage areas of other network access points 12 so as to provide a contiguous service area. In the configuration shown in FIG. 1, the network access points 12A-12N may provide continuous coverage for a campus of buildings occupied by a single entity.

In the distributed architecture of FIG. 1, each of the network access points 12A-12N is a peer to the others and no single network access point 12 is designated as a general controller. The network access points 12A-12N are interconnected by a packet router 14. The packet router 14 also interconnects the network access points 12A-12N to an external packet switched network 16 which may be another private network or public network such as the Internet. The packet router 14 can be an off-the-shelf product which operates according to an industry standard protocol suite. For example, the packet router 14 may be a CISCO 4700 packet router marketed by Cisco Systems, Inc. of San Jose, Calif., USA. The industry standard packet router 14 operates according to the Internet protocol (IP) suite. In such a configuration, individual entities within each network access point 12 are assigned a unique IP address and, when an entity within a network access point 12 wishes to communicate with another entity within the other network access points 12A-12N or with an entity coupled to the packet switched network 16, it passes an IP packet to the packet router 14 designating the destination IP address. In addition to the network access points 12A-12N, other entities may be directly wired to the packet router 14 such as printers, computers, test equipment, servers, dumb terminals or any other manner of equipment with data capabilities. These devices are also assigned IP addresses.

Each network access point 12 comprises one or more land-side wireless modems which may provide communication with a user terminal 18. Each user terminal 18 comprises a remote unit wireless modem. For discussion purposes, we assume that the wireless modems within the network access points 12A-12N and user terminal 18 provide a physical layer in accordance with the modulation and multiple access techniques described in the TIA/EIA Interim Standard entitled “Mobile Station—Base Station Compatibility Standard for Dual-Mode Wideband Spread Spectrum Cellular System”, TIA/EIA/IS-95, and its progeny (collectively referred to here in as IS-95), the contents of which are also incorporated herein by reference or similar subsequent standard. However, the general principles can be applied to many wireless data systems which provide a physical layer interface capable of true mobility.

In FIG. 1, each network access point 12 is coupled with control point capabilities. The control point functionality provides mobility management to the system. The control point functionality executes a plurality of functions such as management of the radio link layer, the signaling protocol and data link layer over the wireless link.

In a typical data system, when a user terminal 18 initially establishes communication with the network, it uses a mobile station identifier (MSID). In one embodiment, the user terminal 18 determines the MSID based upon the network access point's electronic serial number or the mobile identification number or other permanent address associated with the user terminal 18. Alternatively, for increased privacy, the user terminal 18 may select a random number. The user terminal 18 sends an access message to the network access point 12 using the MSID. Using the MSID to identify the user terminal 18, the network access point 12 and user terminal 18 exchange a series of messages to establish a connection. Once an established, encrypted connection is available, the actual mobile station identification can be transferred to the network access point 12 if a random or other nonfully-descriptive MSID has been used.

A temporary mobile station identifier (TMSI) can also be use to identify the user terminal 18. The TMSI is considered temporary in that it changes from session to session. A new TMSI may be selected when the user terminal 18 enters another system in which the new network access point is not directly coupled to the originating network access point 12. Also, if power is removed from the user terminal 18 and then reapplied, a new TMSI may be selected.

The originating network access point 12 in which communication is initially established retains in memory the characteristics of the user terminal 18 as well as the current state of the connection. If the user terminal 18 moves to the coverage area of another network access point 12, it uses a radio address to identify itself to the network access point 12. The new network access point 12 accesses a system memory unit 20 in which the originating network access point 12 is identified as associated with the radio address. The new network access point 12 receives data packets from the user terminal 18 and forwards them to the indicated originating network access point 12 using the IP address specified in the system memory unit 20.

There is therefore, a need to provide a distributed architecture for maintaining a radio session in a wireless communication system, such as one supporting High Rate Packet Data transmissions and services, as well as for those supporting mobile IP communications.

### BRIEF DESCRIPTION OF THE DRAWINGS

The features, objectives, and advantages of the invention will become more apparent from the detailed description set forth below when taken in conjunction with the drawings:

FIG. 1 is a block diagram of a system in which wireless service is provided;

FIG. 2 is a block diagram of a distributed wireless network architecture according to an embodiment of the invention; and

FIG. 3 is a flow chart showing exemplary operation of an embodiment of the invention.

FIG. 4 illustrates compression of an IP address identifying a location of session information according to one embodiment.

FIG. 5 is illustrates construction of a sector identifier according to one embodiment.

FIG. 6 illustrates application of a subnet mask to generate a subnet according to one embodiment.

FIG. 7 illustrates construction of a Temporary Mobile Station Identifier according to one embodiment.

FIG. 8 illustrates two groups of adjacent subnets, associated with a Source Access Network and a Target Access Network, respectively.

FIG. 9 is a table of color code mappings according to one embodiment.

FIG. 10 is a method for processing session information in the Access Network according to one embodiment.

FIG. 11 is an Access Terminal incorporating the session information into a mobile station identifier.

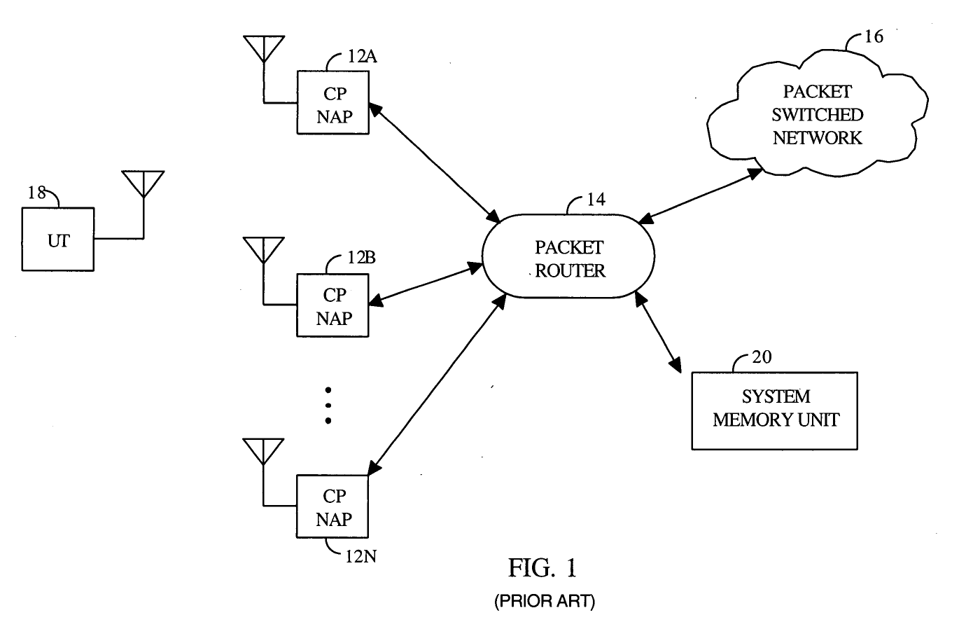

### DETAILED DESCRIPTION

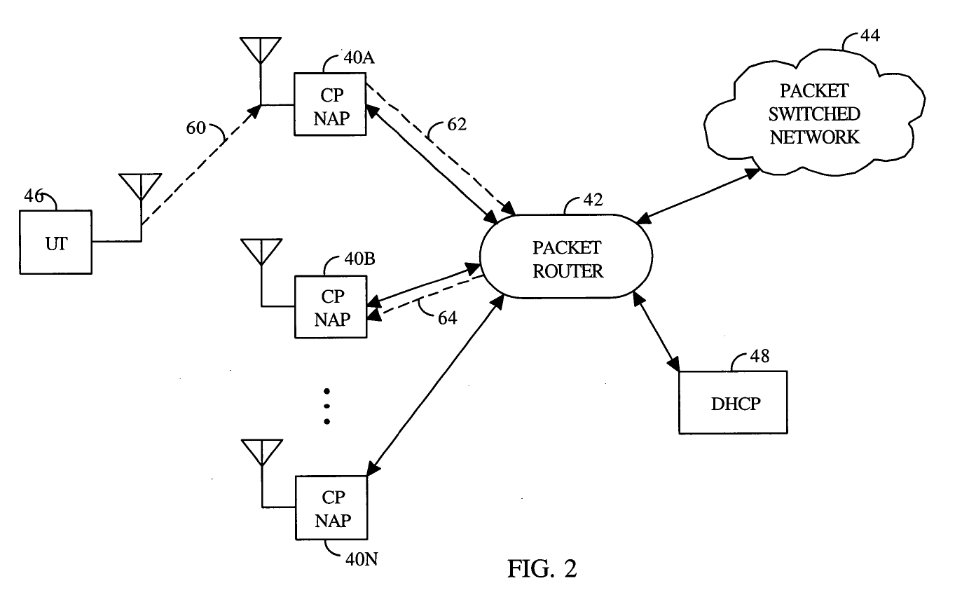

FIG. 2 is a block diagram of a distributed wireless data network architecture according to an embodiment. In FIG. 2, a series of network access points 40A-40N are distributed throughout a service area. In a typical configuration, each network access point 40 has one or more antennas which provide a corresponding coverage area which abuts one or more coverage areas of other network access points 40 so as to provide a contiguous service area. In the configuration shown in FIG. 2, the network access points 40A-40N may provide continuous coverage for a campus of buildings occupied by a single entity.

In the distributed architecture of FIG. 2, each of the network access points 40A-40N is a peer to the others and no single network access point 40 is designated as a general controller. The network access points 40A-40N are coupled to a packet router 42 which provides interconnectivity there between. The packet router 42 also interconnects the network access points 40A-40N to an external packet switched network 44 which may be another private network or a public network such as the Internet. The packet router 42 can be an off-the-shelf product which operates according to an industry standard protocol suite. For example, the packet router 42 may be a CISCO 4700 packet router marketed by Cisco Systems, Inc. of San Jose, Calif., USA.

The standard packet router 42 operates according to the Internet protocol (IP) suite. In such a configuration, individual entities within each network access point 40 are assigned a unique IP address and, when an entity within a network access point 40 wishes to communicate with another entity within the other network access points 40A-40N or with an entity coupled to the packet switched network 44, it passes an IP packet to the packet router 42 designating the source and destination IP address. In addition to the network access points 40A-40N, other entities may be directly wired to the packet router 42 such as printers, computers, test equipment, servers, dumb terminals or any other manner of equipment with data capabilities. These devices are also assigned IP addresses.

Each network access point 40 comprises one or more land-side wireless modems configured to provide communication with a user terminal 46. Each user terminal 46 comprises a remote unit wireless modem which is configured to provide a physical layer for wirelessly coupling the user terminal 46 to the network access points 40.

In FIG. 2, each network access point 40 is coupled with control point capabilities. The control point functionality provides mobility management to the system. The control point functionality executes a plurality of functions such as management of the radio link layer, the signaling protocol and data link layer over the wireless link.

According to one embodiment, when a user terminal 46 initially accesses a system, the user terminal 46 sends an initial access message to the network access point 40 corresponding to the coverage area in which it is located. The initial access message specifies a dummy identifier (DID) for the user terminal 46. The DID may be randomly selected from a fairly small set of numbers or, alternatively, can be determined using a hash function on a larger unique user terminal identification number. According to IS-95, the user terminal 46 uses the mobile station identifier (MSID) as the DID.

The originating network access point 40 perceives the initial access message and assigns an IP address to the user terminal 46. In one embodiment, a static set of IP addresses may be assigned to each network access point 40 and the network access point 40 selects one of the static set of IP addresses for assignment to the user terminal 46. In another embodiment, the system comprises a dynamic host configuration protocol (DHCP) 48 which dynamically assigns IP addresses throughout the system. The DHCP 48 is used as the clearing house to assign available IP addresses.

The originating network access point 40 installs a route for the selected IP address to a controller within the originating network access point 40. For example, depending on the manner in which the IP address is selected, a static or dynamic route for the IP address is established according to well-known techniques. The network access point 40 informs the user terminal 46 of the selected IP address in a message, which designates both the DID and the IP address.

From this point forward in the communication protocol, the user terminal 46 uses the IP address as the MSID. For example, the user terminal 46 sends messages on the access, control, or traffic channels specifying the selected IP address.

In one embodiment, whenever a new or originating network access point 40 receives a message from the user terminal 46, the network access point 40 parses the message to determine the IP address. The network access point 40 creates an IP packet using the IP address as the address. The network access point 40 passes the packet to the packet router 42, which routes the packet according to the IP address. In this way, it is not necessary for a new network access point 40 to access a system-wide memory bank to determine the routing of an incoming packet. Instead, the network access points 40 rely solely on the information received in the packet. The system automatically forwards the IP packet to the appropriate network access controller using well-known techniques.

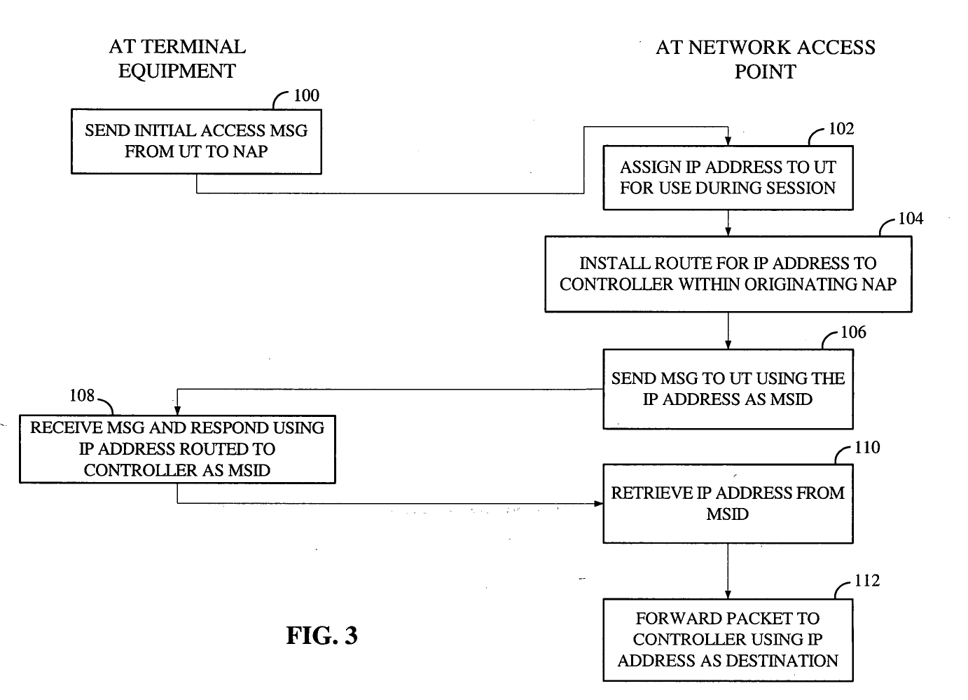

FIG. 3 is a flow chart illustrating operation in accordance with one embodiment. In block 100, a user terminal sends an initial access message to a network access point specifying a dummy identifier. In block 102, an IP address is assigned to the user terminal for use during this session. Note that at this time, the network access point may not know the actual identity of the user terminal. In one embodiment, the IP address can be chosen by a dynamic host control processor. Alternatively, the network access point may select the IP address from a static pool. In block 104, a route is installed for the IP address according to well-known principles. For example, a route is established which routes the IP address to a controller or control functionality within the original network access point which holds the mobile's radio session. In general, a route is established to a controller configured to control the operation of the user terminal throughout the current session such as to provide control point functionality and the controller may be located within a variety of system elements. Each access point is then able to contact the session information by sending a request directly to the location of the session information. In one embodiment, an access point may send a message via mobile IP protocols to request the session information. In such a mobile IP format, the access point provides the destination IP address as that of the location of the session information, and provides its own IP address as the source address. The other provisions of mobile IP which allow movement within a network and into other networks are also available. For example, if the element storing the session information is also mobile, then a home agent may be used to maintain access to that element via mobile IP. In other words, the IP address assigned to the element storing the session information does not change, even when the element changes location and/or connectivity. This provides a fully distributed architecture, wherein each of the elements, including both access terminals and access network elements, may be mobile and flexible, while maintaining access via a same IP address.

In block 106, the network access point sends a message to the user terminal using the dummy identifier as the MSID and specifying the designated IP address within the message. In block 108, the user terminal uses the IP address as a MSID and sends a message to the network access point. For example, in one embodiment, the message is a registration message. In another embodiment, the message carries other overhead information or user data. In block 110, the network access point parses the message to determine the IP address. In block 112, the original network access point forwards a corresponding message to the router using the IP address as the source address. In one embodiment, instead of sending the full IP address, the mobile station may send sufficient information to enable the Radio Access Network (RAN) to reconstruct the IP address of the session holder. In this way, while the full IP address (or a compressed IP address) is assigned to the MSID of the mobile station, the mobile station is not limited to using the exact identifier, but may process such identifier and send the identifier. In this scenario, the mobile station presents the identifier with sufficient information for the access point or access network to retrieve the session information directly.

In a similar manner, other entities coupled to the router can send messages to the user terminal using the IP address. The messages are routed to the original network access point which maintains session information for the user terminal. For example, if a second network access point receives a message from the user terminal, the second network access point creates a corresponding message using the IP address as the destination address and forwards the message to the router. As discussed hereinabove, the second network access point may use mobile IP as a mechanism for obtaining the session information, i.e., communicating with the session holder. For example, referring also to FIG. 2, assume that steps 100, 102, 104, and 106 have been performed so that the user terminal 46 has been assigned an IP address and a corresponding route has been established to a controller assigned to the user terminal 46. Also assume that the network access point 40B is the originating network access point and that that controller is within the network access point 40B. Also assume that the current the user terminal 46 is within the coverage area of the network access point 40A. When the user terminal 46 creates a message, it creates a message identifying itself using the IP address. The message can be created according to the corresponding wireless link protocol. The message is forwarded to the network access point 40A such as over a wireless link path 60. The network access point 40A parses the message to determine the IP address. The network access point 40A creates a packet using the IP address as the destination address. The network access point 40A forwards the message to the packet router 42 such as over a standard IP path 62. The packet router 42 routes the packet to the controller within the network access point 40B such as over a standard IP path 64.

The invention may be implemented in a variety of media including software and hardware. Typical embodiments of the invention comprise computer software which executes on a standard microprocessor, discrete logic, or an Application Specific Integrated Circuit (ASIC.)

The invention may be embodied in other specific forms without departing from its spirit or essential characteristics. The described embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

High Rate Packet Data (HRPD) services, such as the examples specified in the “cdma2000 High Rate Packet Data Air Interface” specification, IS-856, may be referred to as High Data Rate (HDR) systems. An HDR subscriber station, referred to herein as an access terminal (AT), may be mobile or stationary, and may communicate with one or more HDR base stations, referred to herein as modem pool transceivers (MPTs). An access terminal transmits and receives data packets through one or more modem pool transceivers to an HDR base station controller, referred to herein as a modem pool controller (MPC). Modem pool transceivers and modem pool controllers are parts of a network called an access network. An access network transports data packets between multiple access terminals. The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link. The communication link through which a modem pool transceiver sends signals to an access terminal is called a forward link.

Mobile IP as described hereinabove is used to facilitate communications in a wireless network, wherein IP associated protocols is implemented for routing. Alternate methods of implementing wireless communications supporting IP communications are also considered. When an Access Terminal (AT), or mobile station, remote station, etc., initiates a communication, a mobile IP session begins. The mobile IP session has associated session information that the mobile station and access network use to facilitate the communication. Other communication protocols may also be used to facilitate wireless communication between a mobile station and the Internet or other communication system. Such communication protocols have similar exchanges of session information on initiation of a communication. Note that mobile IP is used in a variety of ways in the system. For example, in one instance, the session holder AN is effectively a Mobile Node (MN) as treated in mobile IP, wherein the visiting network (i.e., the entity which the AT accesses) corresponds to the correspondent node (CN) In addition, for IP communications with the AT, the AT has an IP address that is different from the IP address of the session holder. For IP communications with the AT, the AT IP address is used as a destination address, wherein the AT has a home agent for routing information to any location to which the AT may travel. Location here includes both geographical locations, as well as connectivity locations, such as multiple access points, etc.

Generally, when an AT first accesses a wireless Access Network (AN), the mobile station sends an access request message to request access to the AN. The access request message identifies a request for a data service supporting IP communications. The access request message is sent to a Network Access Point (NAP), such as a Base Station, and includes an identification of the mobile station. Such identification may use a temporary identifier, wherein the temporary identifier may change on each access, or may be changed during the registration process. The temporary identifier may be assigned by the AN.

The access request is processed by the AN, wherein the AN determines if the desired service(s) is available and if the AN is able to support the requester at this time. If the AN is able to support the request, a radio session is initiated. A radio session generally refers to a set of parameters and protocols that are used for communication between an AT and an AN. In one embodiment a session may be a data communication via a radio network. When a session is established in response to the access request, the associated session information is stored at a location in the AN. The session information may include encryption specifics, such as encryption keys, radio link layer specifics, such as encoding and/or modulation information, etc. The session information is used to establish the communication channel, or traffic channel, by which the data communication will take place.

According to one embodiment, the storage location of the session information is assigned an IP address. Note that a given IP address identifies a storage location for session information corresponding to a given AT for a current communication session. Such IP address is referred to herein as “session information IP address.” Note that the session information IP address may be used as the home address of the session holder. The session holder corresponds to the element within the AN at which the session information is stored. Note also that when the AT initiates a communication session with the AN, the access request message is sent to an access point within the AN. Once a communication session is established, the AT may move within the AN such that communication with another access point is preferred. In this case, it is desirable for the next AP to retrieve the session information in order to establish the radio connection to continue processing the communication session. Retrieval of the current session information avoids the need to reestablish the session. One embodiment facilitates retrieval of the session information by assigning the session information IP address (corresponding to the storage location of the current session information) to the AT as its radio interface identifier. The AN assigns the corresponding session information IP address to the AT as a Mobile Station Identifier (MSID). The MSID is used to identify the AT during communications with the AN. By using the session information IP address as the MSID, the session information is made available within a distributed architecture. In other words, the AT provides the storage location information sufficient for any access point in the AN to construct the IP address of the session holder and to retrieve the session information. An IP packets has a source and a destination IP address. When a new access point receives the MSID from the mobile station, the access point uses that MSID in order to construct the session information IP address, and the access point sends a request for the session information to the session information IP address. Such request for session information is then received at the storage location and the information provided to the requester in response. For other purposes, the IP address has significance only as the MSID. In other words, any processing related to the MSID, uses the MSID as such. Those IP packets directed to the session information IP address are not routed to the mobile station, but rather are routed to the storage location.

Note that alternate embodiments may use alternate methods to provide an identifier to the mobile station, wherein the methods incorporate the location where the session information is stored in the AN. For clarity throughout this discussion, the IP address associated with the location of the session information will be referred to as “session information IP address,” while the IP address of the AT is referred to as “AT IP address.” In an IP communication, the session information IP address becomes the target address, wherein messages are forwarded to the location in the access network where the session information is stored. Similarly, IP packets with the AT IP address as the destination are routed to the AT.

The session information IP address is the assigned MSID for the AT. Such assignment is processed after the AT requests access to the AN. In response, the session information is stored at a location in the access network, and a session information IP address is assigned to such location. In this way, the AT carries the information sufficient for maintaining the session. The session information is made available to each access point the AT communicates with. The provision of the session information in the MSID allows an access point to access the session information directly and quickly, avoiding the use of an intermediate point for mapping the MSID to a session information storage location.

On initial transmission of an access request, the AT includes a temporary mobile station identifier. This initial temporary mobile station identifier may be a random identifier. The random identifier is used as a temporary identifier until the session information IP address is assigned to the AT as a mobile station identifier. In this way, when an AT first accesses an access point, the access point will select a random identifier and assign that random identifier to the AT. In an alternate embodiment the AT may generate an initial random identifier. Such random identifier is used until the session information IP address is assigned.

The session IP address is obtained from the access point negotiating the original access. The access point may be the storage location of the session information. For example, when an AT registers for access to the AN, the AT provides information to the AN. In response the AN takes this information, relating to the current session, and stores it at a point in the AN. The storage point in the network may be an access point or may be another location or node in the AN. The storage location is assigned an IP address. Such IP address is used to access the session information.

Note that multiple ATs may have session information stored in one location, wherein each AT has session information with a uniquely assigned session information IP address. The session information defines the physical layer processing of communications for the AT. In addition, such information may include other processing information, overhead information, signaling information, compression information, as well as any information useful or beneficial in processing communications with the AT.)

As indicated hereinabove, the session information may be stored in a controller.

The controller may be located anywhere within the AN, including but not limited to, the access point where the communication session began. The controller is responsible for controlling operation of and processing communications with the AN. In other words, the controller facilitates communications with the AN.

When a communication is received from the AT, the AT includes the session information IP address as a mobile station identifier. In a communication system, such as one supporting High Rate Packet Data (HRPD) communications consistent with IS-856, the mobile station identifier may be one of various forms. A first format is referred to as Unicast Access Terminal Identifier (UATI), while a second format is referred to as Temporary Mobile Station Identifier (TMSI). Both are provided as examples in illustrating incorporation of the session information IP address into the mobile station identifier.

The UATI and TMSI each include two fields: one field identifies a subnet within the access network; and a second field identifying the location where the session information is stored within that subnet. In one embodiment a compressed version of the full IP address may be used. Similarly, alternate embodiments may map IP addresses per the particular protocol standards implemented in the system, such as protocols supporting the IEEE 802.11 Wireless Local Area Network standard(s). The use of a compressed IP address reduces the information transmitted on accessing the AN, while providing sufficient information for an access point to locate the session information directly.

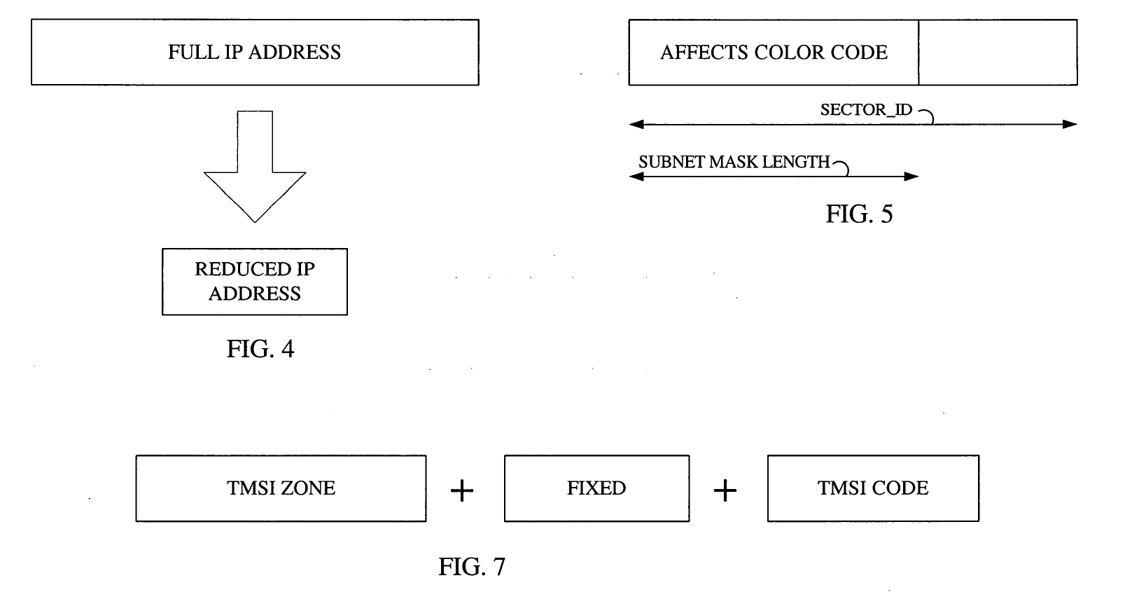

In one embodiment, a color code is used to identify an HRPD subnet. This information allows reduction of the length of the session IP address. The colorcode is locally unique. FIG. 4 illustrates the reduction to a smaller address. The color code identifies an HRPD subnet.

While the Temporary Mobile Station Identifier (TMSI) zone and code, and the Unicast Access Terminal Identifier (UATI) are examples of identification schemes, alternate embodiments may implement other identification schemes. The TMSI and UATI are provided herein as examples. Details of a color coding scheme, as well as generation of the sector identifiers are detailed hereinbelow.

The identifier, illustrated in FIG. 5, provides an example of one embodiment, specific to a UATI scheme. The UATI in one embodiment is a UATI_IPv6 address.

The UATI_IPv6 address serves as a Mobile IP home address within the AN and is used to route packets. In other words, the UATI identifies the IP address of an entity within the network that store the AT's radio session. In this way, the UATI_IPv6 is a home address of the node in the AN storing the session information.

As used herein, the node in the AN maintaining an AT radio session is considered a mobile node. In this sense, the location of the session information within the AN communicates is identified within the network via an IP address. This address is provided as a MSID for a given AT, wherein the MSID refers to a given session.

When the AT moves to a new access point, the static IP address is still used to access the session information for that session.

In the current discussion, the AN, or the node within the access network storing the session information, acts as the mobile node. The concept of maintaining an IP address for accessing the session information provides a distributed architecture, as the AT provides sufficient information for an access point to communicate directly with the location storing the session information. In this way, the need to map a MSID to the session information location is avoided.

The TMSI includes a TMSI zone and a TMSI code. In one embodiment, implementing an IPv6 address, the TMSI zone is 64 bits, and the TMSI code is 24 bits.

The TMSI zone is set to the 64-bit IPv6 prefix, and the TMSI code is chosen to provide a unique identifier within the TMSI zone. The pair of TMSI zone and TMSI code is then globally unique, as long as the TMSI zone is globally unique.

FIG. 7 illustrates the application of a TMSI zone and TMSI code to the mobile station identifier. As illustrated, a first portion is assigned to the TMSI zone, and a second portion assigned to the TMSI code. Additionally there is a reserved portion provided between the TMSI zone and the TMSI code.

In one embodiment, the location identifier, e.g., IP address, of the session information is provided as the MSID, wherein the full location identifier is reduced to a smaller number. One embodiment of such compression uses color codes, as described hereinabove. The following provides an example of color codes and the application of color codes to the assignment of such an MSID. In the following embodiment, the AN is treated as a mobile node, wherein the location within the AN storing session information is accessed via a location identifier. The AT uses the location identifier as an MSID. Through use of a sector identification scheme, such as color coding, the AT may use a reduced address, wherein each access point may reconstruct the full address within the framework of such sector identification scheme. Color coding is provided as an example of a sector identification scheme. Alternate embodiments may implement other schemes which provide reduced addresses.

Color Codes

The following describes one embodiment, wherein color codes are used along with subnets to facilitate session transfers in a system supporting IS-856. As used herein, Access Network (AN) may contain of one or more Sectors and one or more Subnets.

The following discussion assumes the language of the IS-856 specification, however, alternate embodiments may incorporate other language consistent with the definitions provided. The sector address, such as a 128 bit address, is referred to as the “SectorID.” The structure of a SectorID and UATI in IS-856 are given as in FIG. 5. The SectorID has a bit length “L” and is divided into two portions. The “n” MSBs represent the identifier for the subnet and the lower (L-n) bits identify a particular sector within a subnet. As illustrated, n is the length of the subnet mask. A subnet mask of length n is a L-bit value whose binary representation consists of n consecutive ‘1’s followed by (L-n) consecutive ‘0’s.

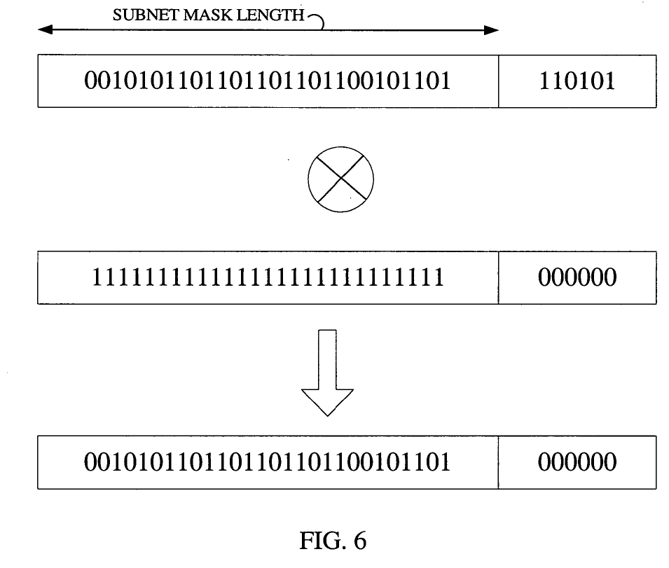

FIG. 6 illustrates application of a subnet mask to a SectorID. The subnet for a SectorID (e.g., UATI) is obtained by performing a logical AND of the sector address and the subnet mask. Each sector advertises a SectorID and SubnetMask, which identifies the sector. In this way, the AT recognizes entry to the foot-print of a new subnet. In other words, the SubnetMask isolates the subnet portion of the SectorID. The UATI has the same structure as the SectorID.

ColorCodes are used in IS-856, as the 128-bit UATI does not fit in the long code mask and, therefore, sending a 128-bit UATI consumes space in the Access and Control Channel messages. An 8-bit Color Code (CC) is used as an alias for the subnet address. The ColorCode effectively compresses the subnet portion of the SectorID resulting in an 8-bit field. When the subnet of the sector changes, the ColorCode changes. For Unicast packets, the Medium Access Control (MAC) Layer header of the Control Channel and the Access Channel includes a concatenation of the CC with the least significant bits of the UATI, represented as: ColorCode|UATI[23:0]. In other words, the CC replaces the subnet portion. The ColorCode has a short bit length, in this example only 8-bits, and, therefore, is not globally unique. This leads to the implementation of design rules for assigning ColorCodes to subnets.

Specifically, the AN incorporates a re-use scheme for ColorCode to ensure adjacent sectors in different subnets do not advertise the same ColorCode. More specifically, the ColorCode re-use scheme ensures there is no sector having two or more neighboring sectors which are in different subnets but which use the same ColorCode.

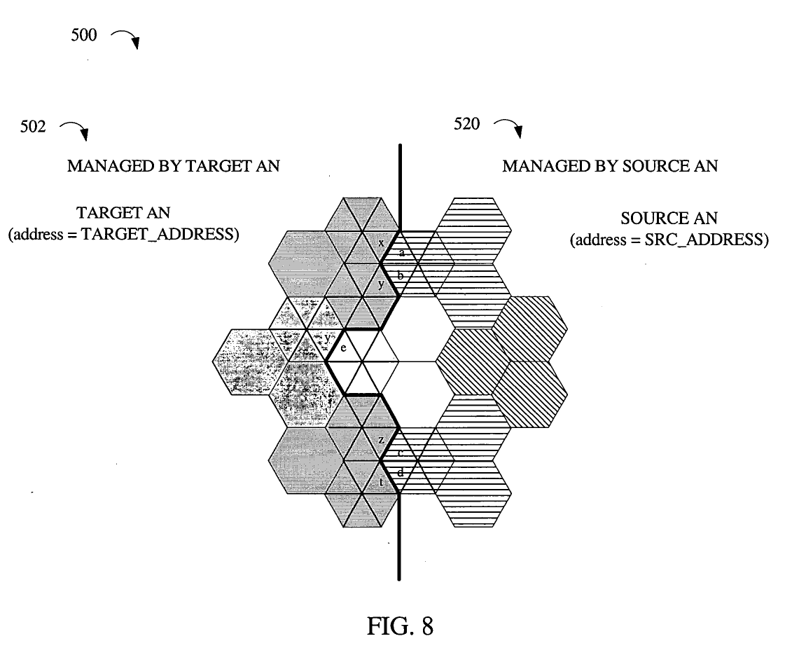

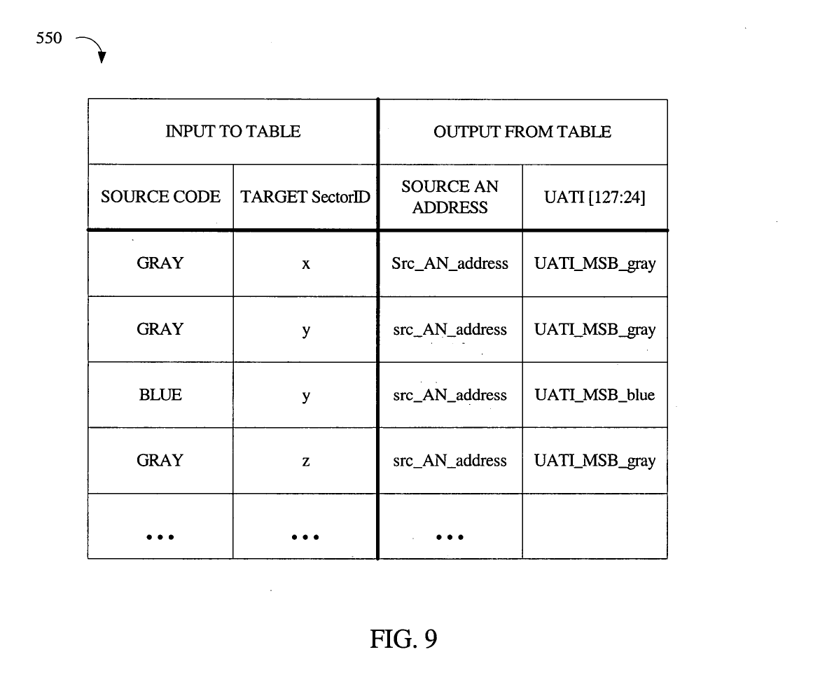

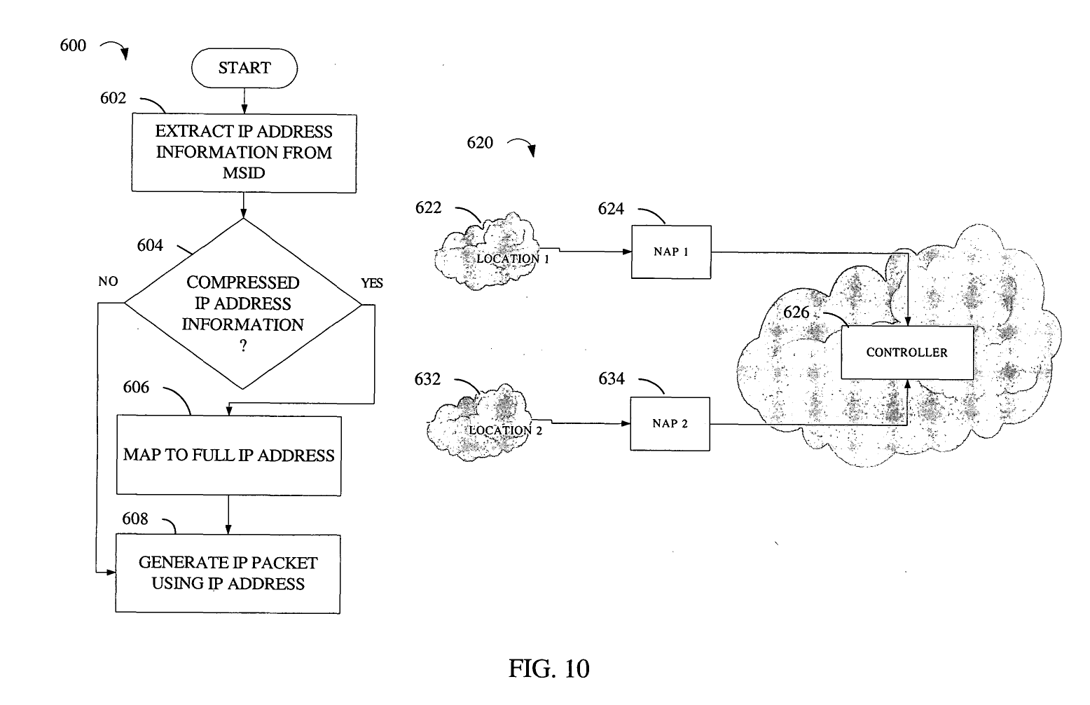

FIG. 8 illustrates a re-use scheme according to one embodiment. The AN includes multiple sectors. Each sector has multiple subnets, not all of which are shown in FIG. 8. Note each sector may include any number of subnets. As illustrated by the shading, no neighboring sectors have a same color code. Further still, no sector has two neighboring sectors with a same color code.

For a given Subnet Sector, the AT uses (ColorCode|UATI[23:0]) for identification. The AN addresses the AT on the Control Channel using the same address Subnet with the same Color Code. It is possible, and likely, that ColorCode values will be reused across ANs and within the same AN.

The Target AN is able to locate the Source AN, as the AT includes the “ColorCode|UATI[23:0]” in the MAC Layer header of every Access Channel capsule sent by the AT. The As an AT moves from AN1 to AN2, AN1 is referred to as the source AN and AN2 is referred to as the Target AN. The ColorCode that the ATreports is associated with the source AN. This information is included in the Access Channel capsule containing the UATIRequest message that the AT sends when it enters a new subnet.

The Target AN may be provisioned with a table mapping the <Source ColorCode, TargetSectorID>to the address of the Source AN. In particular, for each Target AN Sector a table may map the ColorCode of each of that Sector's adjacent subnets to the address of the AN responsible for the subnet. The Target AN determines the address of the Source AN that corresponds to the ColorCode received in the MAC Layer header by performing a table look-up in the table.

FIG. 8 illustrates a communication system 500 having two groups of adjacent subnets denoted by Source Subnets and Target Subnets. The Source subnets are part of a Source AN 520, while the Target Subnets are part of a Target AN 502.

FIG. 19 illustrates a portion of a mapping table 550 maintained by the Target AN 502. Note the table 550 may be maintained in a distributed manner by each of the sectors of the Target AN 502. For example, in table 550, all the rows with the “Target SectorID” set to ‘y’ may be maintained in the entity that manages sector ‘y’. Once the Target AN 502 discovers the address of the Source AN 520, the Target AN 502 identifies the information of the desired session for the AT as located at the Source AN 520. Such a ColorCode mapping bable 550 has a column storing the 104 most significant bits of the UATI associated with the Source ColorCode. Therefore, the Target AN 502 may construct the 128-bit UATI by concatenating the value obtained from this column with the UATI[23:0] obtained from the AT. Even when the value of the SubnetMask is less than 104, there is no loss of generality in mapping the Source ColorCode to a 104-bit value for the purpose of reconstructing a 128-bit UATI. The “ColorCode|UATI[23:0]” is used on the Control Channel and Access Channel and in the Reverse Traffic Channel long code mask to identify the AT. The value of the ColorCode is the same within a subnet, wherein UATI[23:0] is unique within a subnet. Therefore, “SectorID[127:127-SubnetMask]|UATI[23:0]” uniquely identifies an AT, independent of the value of the SubnetMask. The Source AN 520 operator provides the Target AN 502 operator with 104-bit values to provision in the UATI[127:24] column of the Target AN 502 ColorCode mapping table 550. If the Source SubnetMask is less than 104 bits, the Source AN 520 operator chooses a fixed value for the “middle bits” in order to create the 104-bit value.

If the Target AN 502 sends the AT's “ColorCode|UATI[23:0]” to the Source AN 520 to retrieve the AT's session, the “ColorCode|UATI[23:0]” is not sufficient information for the Source AN to locate the AT's session. Consider the following examples:

Case 1) An AT moves from sector ‘a’ to sector ‘x′’; and

Case 2) An AT moves from sector ‘c’ to sector ‘z’.

In each case, the Target AN 502 sends the same ColorCode (i.e., gray) to the Source AN 520 in the session retrieval request. The Source AN 520, however, is not able to map the value of the ColorCode to a unique subnet. In order to map the ColorCode to a unique subnet, the Source AN 520 is provisioned with an additional table that maps <Source ColorCode, Target SectorID>to the MSBs of the subnet associated with the Source ColorCode, and the session retrieval request includes the Target SectorID.

In the table 550, the Source Code refers to the ColorCode of the Source AN 520, or specifically to the subnet within a sector of the Source AN 520. The Target SectorID refers to the SectorID of the Target AN 502, such as identified by sectors in FIG. 8.

Operation:

In operation, once the session information IP address assignment is made, each subsequent access point accessed will receive the information necessary to maintain the session. FIG. 10 illustrates processing at an AN 620 after the session information IP address has been assigned as a mobile station identifier to an AT (not shown). The AT is first located at a Location 1 622, where an initial access request is made. The session is established and session information stored in controller 626 located within AN 620. From Location 1 622, the AT accesses the AN 620 via NAP 1 624. The AT then moves to Location 2 632 and desires to continue the session. From Location 2 632, the AT accesses AN 620 via NAP 2 634. In this example, a compressed session information IP address has been assigned to an AT. The compressed session information IP address is locally unique, but not necessarily globally unique. On receipt of the mobile station identifier the AN 620 treats the mobile station identifier as an IP address. In other words the mobile station identifier is read as a target IP address for accessing session information relating to this AT.

Note that the AN 620 will use this number as a mobile station identifier for all functions related to mobile station identification. This is in addition to the concurrent use of such information to locate the session information for communication with the AT. At step 602 the AN receives the MSID and treats the MSID as an IP address. The AN determines, step 604, if the session information IP address is compressed. If the address is not compressed, processing continues to step 608, else at step 606 the access network maps the compressed IP address to a full IP address. This is possible as the AN has knowledge of the color coded portion or sector of the AN within which the AT is currently located. At step 608 the access network creates a packet with the IP address as the target address. The packet requests the session information from the controller, wherein the session information is stored in the controller identified by the session information IP address. Note that it is the controller, in one embodiment, that assigns the session information IP address initially.

The AT may send a compressed version of the IP address to the AN on the reverse link. In this way the compressed version contains a locally unique number. When the AT is idle and the AT is expected to remain within a color sector or portion of the access network, the compressed version is assigned to the AT for use as a mobile station identifier. When the AT is not idle, the access network will assign the full IP address to anticipate movement of the AT within various color sectors or portions of the network.

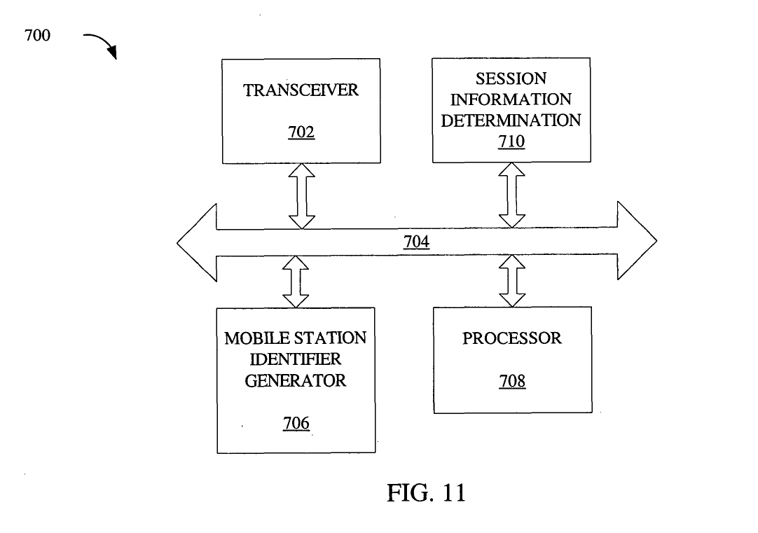

FIG. 11 illustrates an AT supporting MSID assignment incorporating session information. The AT 700 includes transceiver 702, session information determination unit 710, mobile station identifier generator 706, and processor 708, each coupled to a communication bus 704. The AT 700 receives a mobile station identifier via the transceiver 702, which is processed in session information determination unit 710. The session information determination unit 710 receives the session information IP address, or other pointer to the retrieval location of the session information; and provides such information to the mobile station identifier generator 706. The mobile station identifier generator 706 generates the identifier for transmission via the transceiver 702. The mobile station identifier generator 706 includes the session information IP address, or other pointer to the retrieval location of the session information, in the mobile station identifier. Note that on initial access, the mobile station identifier generator 706 generates a temporary identifier, which may be a random identifier. The session information provides a pointer to the retrieval location of the session information. In this way, the precise storage location is not required, but rather information sufficient to access the session information.

As described herein, assignment of a session information IP address for use as a mobile station identifier facilitates a distributed architecture for processing IP communications in coordination with a wireless communication system. The session information IP address identifies a storage location of session information for a given AT. The AT effectively carries a pointer to the session information, wherein an access point is able to access the session information directly. This avoids the need to store mapping information for each AT and associated location of session information.

Additionally, this avoids delays incurred by such mapping. The session information IP address may be compressed to use a locally unique value. The compressed version conserves bit space, and reduces processing complexity on relocation to a next access point.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. An access terminal, comprising:
transceiver means adapted for high rate packet data communications;
session information identification means for providing a location of session information for a current data communication session, wherein the location information identifies a storage location external to the mobile station.

2. The access terminal as in claim 1, wherein the location of the session information is identified by a first Internet Protocol (IP) address.

3. The access terminal as in claim 2, wherein the transceiver means is further adapted to receive the location of session information and provide the location of the session information to the session information identification means.

4. The access terminal as in claim 1, wherein the session information identification means comprises:
session information determination means adapted to receive the location of the session information; and
mobile station identifier generator, wherein the mobile station identifier generator uses the location of session information as a mobile station identifier.

5. The access terminal as in claim 4, wherein the mobile station identifier generator provides a pointer to the location of session information.

6. The access terminal as in claim 4, wherein the mobile station identifier generator provides an initial random identifier prior to receiving the location of the session information.

7. The access terminal as in claim 6, further comprising:
a processor adapted to initiate an access request, wherein the access request initiates a session.

8. The access terminal as in claim 4, wherein the mobile station identifier generator provides a compressed version of the location of session information.

9. The access terminal as in claim 8, wherein the location of session information is identified by an Internet Protocol (IP) address wherein the IP address is constructed using the compressed version of the location.

10. The access terminal as in claim 9, wherein the mobile station identifier generator provides a portion of the IP address as a mobile station identifier.

11. The access terminal as in claim 10, wherein the portion of the IP address is locally unique within a current portion of a communication system.

12. A method for a communication session in a wireless communication system supporting Internet Protocol (IP) communications, the method comprising:
receiving a request for a first communication session;
establishing the first communication session;
storing session information for the first communication session in a first location;
determining a session information IP address to the first location; and
assigning the session information IP address to a mobile station identifier for an access terminal participant to the first communication session.

13. The method as in claim 12, wherein the mobile station identifier includes a color code corresponding to a portion of the wireless communication system.

14. The method as in claim 13, wherein the color code is a compressed version of a sector identification value.

15. Apparatus in a communication session in a wireless communication system supporting Internet Protocol (IP) communications, the apparatus comprising:
means for receiving a request for a first communication session;
means for establishing the first communication session;
means for storing session information for the first communication session in a first location;
means for determining a session information IP address to the first location; and
means for assigning the session information IP address to a mobile station identifier for an access terminal participant to the first communication session.

16. A method for a communication session in a wireless communication system supporting Internet Protocol (IP) communications, the method comprising:
receiving a message from an access terminal, the message including a mobile station identifier;
extracting a session information IP address from the mobile station identifier;
requesting session information using the session information IP address;
receiving the session information; and
processing the communication session with the access terminal.

17. The method as in claim 16, wherein the session information IP address is a compressed value, the method further comprising:
mapping the session information IP address to a full IP address; and
generating an IP packet using the full IP address.

18. An apparatus for a communication session in a wireless communication system supporting Internet Protocol (IP) communications, the apparatus comprising:
receiving a message from an access terminal, the message including a mobile station identifier;
extracting a session information IP address from the mobile station identifier;
requesting session information using the session information IP address;
receiving the session information; and
processing the communication session with the access terminal.

19. The apparatus as in claim 18, wherein the session information IP address is a compressed value, the apparatus further comprising:
mapping the session information IP address to a full IP address; and
generating an IP packet using the full IP address.

20. The apparatus as in claim 19, wherein the compressed value is locally unique within a portion of the wireless communication system.

21. A session holder in a wireless communication system supporting Internet Protocol (IP) communications, the session holder being assigned an IP address, the session holder comprising:
receiver for receiving a request message, the request message having a destination portion identifying the element;
memory storage unit for storing session information for a first session;
transmitter for sending a response to the request message, the response including at least a portion of the session information for the first session.

22. An infrastructure element in a wireless communication system supporting Internet Protocol (IP) communications, the element having an IP address, the element comprising:
receiver for receiving a communication from an access terminal, the communication including a mobile station identifier;
processor coupled to the receiver, the processor determining a session holder IP address from the mobile station identifier; and
means for sending an IP request for session information of the communication with the access terminal, wherein the IP request uses the session holder IP address as a destination address .
